(19) United States
(12) Patent Application Publication
(10) Pub. No.: US 2003/0149567 A1
(43) Pub. Date: Aug. 7, 2003

(54) Method and system for using natural language in computer resource utilization analysis via a communications network

(76) Inventors: Tony Schmitz, Gaysville, VT (US); Ashish Pant, New York, NY (US); Michael Pisula, New York, NY (US); Giorgio Scherl, Buochs (CH); Roman Shenkerman, Manalapan, NJ (US); Alexandros Tsepetis, New York, NY (US)

Correspondence Address: MORRISON & FOERSTER LLP, 1650 TYSONS BOULEVARD, SUITE 300, MCLEAN, VA, 22102, US

(21) Appl. No.: 10/061,188

(22) Filed: Feb. 4, 2002

(51) Int. Cl. G10L 21/00; G06F 15/16

(52) U.S. Cl. 704/270; 709/217

(57) ABSTRACT

A client system issues a request for a resource over the Internet from a resource server. In constructing the response, the resource server includes: the data requested by the client, additional instructions for the client system to perform upon arrival of the response, and a natural language identifier which describes the resource requested by the client called the taxonomy string. Upon arrival of the response, the additional instructions inserted by the server system cause the client system to send a subsequent request over the Internet to an analytics system. The analytics request may contain a natural language description of the requested resource and a unique identifier to uniquely identify the client system. The analytics system performs analysis on the natural language identifier and stores it in a taxonomy database. The analytics system also performs calculations using the data provided in the analytics request to determine resource utilization patterns.

### BACKGROUND OF THE INVENTION

1. Field of the Invention

The present invention relates to a method and system for using natural language taxonomy in the analytics of computer resource utilization via the Internet.

2. Description of the Related Art

The Internet comprises a vast number of computers and computer networks that are interconnected through communication links. The interconnected computers exchange information using various services. These services include electronic mail, Gopher, and the World Wide Web (“WWW”). The WWW service allows a server computer system (i.e., Web server or Web site) to send graphical Web pages, or other resources of information, to a remote client computer system. The remote client computer system can then display or store the data depending upon the nature of the original request. Each resource (e.g., computer or Web page) of the WWW is uniquely identifiable by a Uniform Resource Locator (“URL”). To access a specific resource, a client computer system specifies the URL for that resource in a request (e.g. a HyperText Transfer Protocol (“HTTP”) request). The request is forwarded over a communications network from the client to the server specified in the URL that supports that particular resource. When that resource server receives a valid request, it returns the requested resource data to the client computer system. Based upon the nature of the data returned, the client computer system may locally store the information or invoke the application that is best suited to present the data to an end user. If the resource requested is a Web page, the client computer system typically displays the returned data using a browser. A browser is a special-purpose application program that effects the requesting and displaying of Web pages.

In their most basic form, Web pages are defined using HyperText Markup Language (“HTML”). HTML provides a standard set of tags that define how the text within a Web page is to be displayed. When a user requests that the browser display a Web page, the browser sends a request to the server computer system to transfer an HTML document, which defines the Web page, to the client computer system. When the requested HTML document is received by the client computer system, the browser displays the Web page as it is defined by the HTML document. The HTML document may contain various tags that control the displaying of text, graphics, controls, and other features. The HTML document may contain URLs of other Web pages which are available on that server computer system or other server computer systems. More complicated Web pages may contain other computing instructions within the HTML that extend beyond merely formatting the returned text. These instructions may be sent to a browser on the client's system in the form of a computer scripting language. When the browser detects computer scripting language in a received HTML page, it executes the instructions within the script in accordance with the specifications of the scripting language and the browser. These embedded scripts are typically used to create more dynamic and interactive Web pages than those that use strict HTML.

Since the inception of the WWW, it has been necessary for Web server operators to understand what resources client systems are requesting and whether or not those requests are successful. Previously, this information was extracted from Web server log files. Each time a Web server fulfilled a resource request, it created a log entry in a computer file residing on the server computer system. At a minimum, the log entry contained the date and time of the request, the URL requested by the client, and an indication of whether the request was successful. Each request handled by a Web server had a corresponding entry in the server's log file. The data in the log files was designed for auditing Web site activity. Web server operators used computer programs called log file parsers to analyze the log data and compile utilization reports.

As businesses began to leverage the Web as a new channel for attracting customers and selling products, the limitations inherent in log file parsing programs became more evident. Specifically, parsing programs had a difficult time keeping pace with the rate of transactions generated on a given Web site. Often, the time required for parsers to generate reports was too great for the reports to be useful. Additionally, as Web sites became distributed across multiple server computers, a single Web site would create multiple log files to be parsed. While many parsing programs attempted to address this issue, the end result was often unreliable and inaccurate.

Another fundamental limitation of parser reports is their high degree of dependence upon URLs for information. As the resources available via Web servers move away from static HTML pages and images, the data contained in the URLs sent by clients is less representative of the content of the requested resource. URLs that request dynamically generated resources are encoded in a way to be understood by the computer programs generating the responses. As a result, the URL based parser reports held little meaning for Web site operators, or business units attempting to make decisions.

The study of Web site and resource utilization has come to be known as Web Analytics. Many solutions have been deployed that offer Web server operators viable alternatives to log file parsers. While these alternatives do address many of the shortcomings of the log file strategy, they are still constrained by not providing a Web site operator with the ability to assign a useful, natural language description to the resource requested by the end user.

### SUMMARY OF THE INVENTION

An embodiment of the present invention provides a method and system for using natural language taxonomy in the analytics of computer resource utilization via the Internet. According to this embodiment, a client system may request a computing resource from a resource, or Web, server. Before the resource server returns the requested data to the client system, it may embed additional information in its response. This information may include additional instructions for the client system to execute upon receipt of the response from the resource server. This information may also include a natural language taxonomy description of the resource requested by the client system.

According to this embodiment, when the client system receives a response from the resource server, it may begin to execute the additional instructions which were embedded in the response by the resource server. These instructions may cause the client system to issue an additional request to an analytics system. This analytics request may contain information relating to the client system in the form of a unique client identifier. The analytics request may also contain a natural language taxonomy assigned by the resource server to a computing resource requested by the client system. When the analytics system receives the analytics request from the client system, it preferably verifies that the analytics request contains a client identifier. If the analytics request does not contain a client identifier, the analytics system may calculate a new identifier which can uniquely identify the client system. If the analytics request contains a pre-existing client identifier, that client identifier is preferably preserved. Having determined the correct client identifier for the client system, a message is sent to an analytics sub-system. This message is comprised of the client identifier and the taxonomy information contained in the client analytics request. The message sent to the analytics sub-system is known as an analytics object. Following delivery of the analytics object to the correct subsystem, the analytics system issues its response to the client system, which may contain the client identifier if a new one was assigned.

Upon receipt of the analytics object by the appropriate sub-system, the analytics system may perform further processing on the information contained in the analytics object. Most importantly, the analytics system may extract the natural language taxonomy included in the analytics object. The analytics system may also store that taxonomy string in a taxonomy database. The analytics system may also assign a numeric identifier to that particular natural language taxonomy string. Once this numeric taxonomy identifier is obtained, it may be used in concert with the client identifier to record and analyze the resources which were accessed by the client system. While the system of this embodiment results in the analytics request being transparent to the user of the client system, additional embodiments are provided in which the analytics request may not be transparent to the user of the client system.

The values calculated from the analysis of client analytics requests may be stored in an analytics database. The information in the taxonomy and analytics databases may then be utilized by other computing applications for informational purposes or as input to other business logic based applications, for example.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

The above objective and advantages of the present invention will become more apparent by describing in detail a preferred embodiment thereof with reference to the attached drawings in which:

FIG. 1(A) is an example of an HTML resource according to the prior art;

FIG. 1(B) is an example of an HTML resource containing sample natural language taxonomy and pseudo code according to an embodiment of the invention;

FIG. 2 is a block diagram of an example of a system according to an embodiment of the invention;

FIG. 3 is a flow diagram of an example of the interaction between the client and resource servers according to an embodiment of the invention;

FIG. 4 is a flow diagram of an example of the interaction between the client and the analytics systems according to an embodiment of the invention;

FIG. 5 is a flow diagram of an example of an algorithm for using taxonomy elements according to an embodiment of the invention;

FIG. 6 is a flow diagram outlining an example of an algorithm for storing taxonomy elements in the taxonomy database according to an embodiment of the invention;

FIG. 7 is an example of a report which details resource utilization based upon taxonomy strings according to an embodiment of the invention;

FIG. 8 is an example of a report which details resource utilization based upon taxonomy elements according to an embodiment of the invention; and

FIG. 9 is an example of a report which details visitor classification base upon taxonomy elements according to an embodiment of the invention.

### DETAILED DESCRIPTION OF THE PREFERRED EMBODIMENTS

Reference will now be made in detail to the preferred embodiments of the present invention, examples of which are illustrated in the accompanying drawings, wherein like reference numerals refer to the like elements throughout. The embodiments are described below in order to explain the present invention by referring to the figures.

An embodiment of the present invention provides a computer method and system for using natural language taxonomy in the analytics of computer resource utilization via the Internet. In comparison to URLs, the natural language taxonomy can provide a more intuitive and human readable description of computing resources. The taxonomy may be defined as a series of arbitrary attribute-value pairs deemed to be an appropriate description of a Web site's, or resource server's, operator. The words used as attributes and their corresponding values may be arbitrary selected. Additionally, there is no limitation placed upon the number of attribute-value pairs that may comprise a taxonomy string. In a preferred embodiment, a Web site operator's natural language and/or business lexicon is used to describe the contents of resources available through a given resource server. This taxonomy is ideal in situations in which the information encoded with a URL is inadequate, unintelligible, or unavailable.

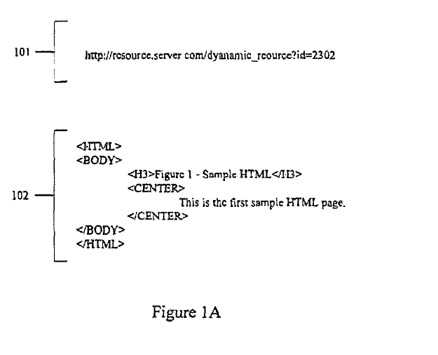

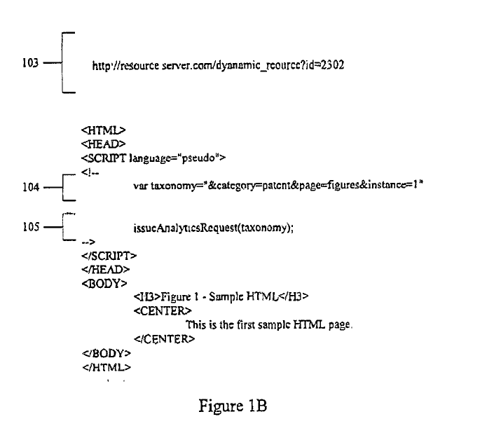

FIGS. 1A-B illustrate an example of the usage of taxonomy in an HTML request and response according to an embodiment of the invention. FIG. 1A illustrates an example of the contents of an HTML response both with and without the presence of a taxonomy based analytics system. In this example request and response interaction, a client may send a URL 101 to a response server that programmatically generates a response 102. Comparing the URL and the contents of the response, the URL has very little context dual data regarding the response sent back to the client. When the client receives this response, it may display the text in accordance with the specifications of HTML tags. No further actions would be performed on behalf of the client.

FIG. 1B illustrates the same URL request and response illustrated in FIG. 1(A), including an integrated taxonomy driven analytics system according to an embodiment of the invention. In this example, the requested URL 103 has gone unchanged from the previous example. However, the response sent back by the resource server has been altered. The request may now contain a small script that includes a taxonomy description 104 corresponding to the requested resource. The request may also include an instruction to the client system to perform an analytics request 105. When the client system receives this response from the resource server, it may display the text of the HTML page. Similarly, the client system may execute a script included by the resource server. The taxonomy string is defined in this script. The taxonomy string preferably includes a series of attribute-value pairs. The attributes in the provided taxonomy example are “category”, “page”, and “instance”. The natural language words that are defined to be attributes may be arbitrary and selected by a Web server operator. These values are “patent”, “figures”, and “1”, respectively, in this example. As with the attributes, the words that serve as the values for the given attributes may be arbitrary and selected by the Web server operator. The resulting attribute-value pairs used in the illustrated examples are “category=patent”, “page=figures”, and “instance=1”. In this example, the “&” character is used as a delimiter between the attribute-value pairs that comprise the taxonomy description. When the client executes the analytics request 105, the client system may send the contents of the taxonomy string 105 as part of the analytics request. This taxonomy string may then be used by an analytics system as the basis for resource utilization calculations. When comparing the request URL 103 to the taxonomy description 104, it is evident that the taxonomy driven analytics provides more contextual and descriptive information.

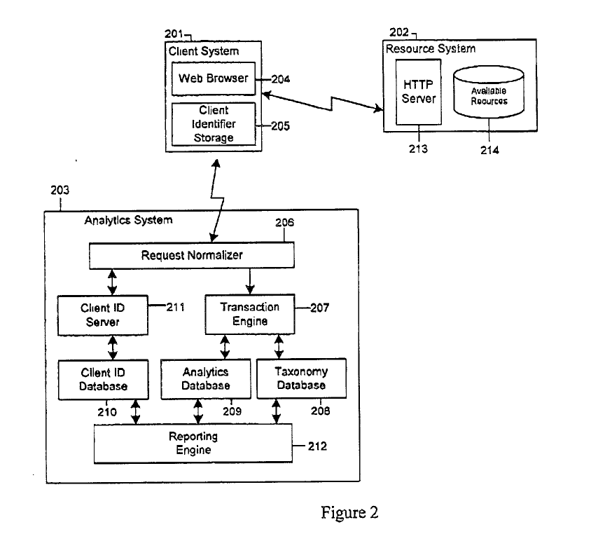

FIG. 2. a block diagram of an example of a system according to an embodiment of the invention. A client system 201 may access both a resource server 202 and an analytics system 203 via a network, for example, or via some communications link. The client system 201 preferably includes an application to access remote resources. In illustrated example, a web browser 204 is included as part of the client system 201 to access the WWW. Further, the client system preferably includes a client identification storage unit 205 to store its client identifier.

The resource server 202 may communicate with remote systems (not shown) over a network or type of communications link. In the most general sense, the resource server should have a collection of resources 214 and a mechanism for accessing those resources 213. In FIG. 2, the illustrated mechanism 213 is a Web, or HTTP, server. The available resources 214 can include, but are not limited to, static documents stored on the resource server's disk and an inventory database to which the resource server 202 has access. The nature of the available resources may vary. However, it is important that the resource server 202 can construct responses to client requests that include the taxonomy description and trigger an appropriate analytics request from the client system 201.

The taxonomy description may be delivered by the resource server 202 as a portion of a response to a request from the client system 201. The user may initiate the client request by entering a resource URL into the web browser 204. The web browser 204 may then issue a request to the resource server 202.

In the absence of a taxonomy driven analytics system, a resource server would receive a client request, determine the validity of the request, and return an appropriate response. If the request was invalid, the resource server should return an error. If the request was valid, the resource server should return a resource as defined by the URL requested by the client. With the integration of a taxonomy based analytics system, the resource server 202 may perform two additional steps before returning a response to the client system 201. First, the resource server 202 may insert an appropriate taxonomy description string as defined by a Web site operator. Additionally, the resource server 202 may include additional instructions to be executed by the client system 201 upon receipt of the response from the resource server 202. Once this additional information has been included, the resource server 202 may deliver the response to the client system 201.

Upon receipt of the requested data, the client system 201 may display the results of the URL request to the end user. Additionally, the web browser 204 may execute the additional instructions inserted by the resource server 202. The most basic of these instructions may instruct the web browser 204 to issue an analytics request to an analytics system 203.

According to this embodiment, the analytics system 203 is comprised of, but not limited to, seven fundamental subsystems including a request normalizer 206, a transaction engine 207, a taxonomy database 208, an analytics database 209, a client identifier database 210, a client identifier server 211 and a reporting engine 212.

The request normalizer 206 preferably validates the client identifiers which have been sent from the client system 201. The request normalize 206 may reformat an analytics request to be processed by the transaction engine 207 and issue responses to client system 201. The first step during each analytics request preferably includes validating client identifiers. If no client identifier is provided to the analytics system 203 by the client system 201, or if the client identifier is deemed to be invalid, the request normalizer 206 may obtain a valid client identifier via a request to the client identifier server 211. In order to accurately trend user behavior, care is taken to ensure that the client system 201 retains the same client identifier for as long of a time period as possible. The client identifier server 211 may then retrieve a next appropriate value from the client identifier database 210. This client identifier may then be sent to the request normalizer 206. Brokering these requests, and interacting with the identifier database is the responsibility of the client identifier server 211. Once a valid client identifier is obtained, the request normalizer 206 may issue a response to the client system 201 with the appropriate client identifier. Then, the request normalizer 206 may reformat the data contained in the client system's analytics request and construct an analytics object to be sent to the transaction engine 207 for further processing.

Preferably, all of the analytics take place within the transaction engine 207 upon receiving the analytics object. The transaction engine 207 receives analytics requests as objects. From these objects, the transaction engine 207 preferably extracts the client identifier inserted by the request normalizer 206 and the taxonomy description. The transaction engine 207 may use the client identifier and the taxonomy description, together with other pieces of information embedded in the analytics request including the date and time of the request, to update the analytics database 209 and the taxonomy database 208.

Upon receipt of the analytics object, the analytics system 203 preferably begins its analysis of the client request. The most fundamental of which is to extract and store the taxonomy data inserted by the Web server in a taxonomy database. This is performed by disassembling the full taxonomy description into its attribute-value components. Each attribute, value, and attribute-value combination has their own entry in the taxonomy database 208, in addition to a numeric identifier.

When all the attribute-value pairs that comprise a taxonomy description have been stored in the taxonomy database 208, an attribute-value composite string may be generated. This composite string may be stored in the taxonomy database 208 and assigned a unique numeric identifier known as an avcomp id. The avcomp id may be used as the basis for all Web site usage statistics and analytics generated by the analytics system 203. As the analytics system 203 completes it calculations on a particular object, it may store the results in the analytics database 209. Other applications may then leverage the presence of the taxonomy database 208 and the analytics database 209 to present real-time resource utilization statistics keyed off of taxonomy data.

The transaction engine 207 preferably uses the taxonomy data in conjunction with the client identifier to develop a visitor profile. The visitor profile may be a historic record of a client system's 201 activity that is stored and maintained in the analytics database 209. The data maintained as the visitor profile may contain, but is not limited to, the number of resources requested, the first resource requested, the last resource requested, the date and time of the first request and the date and time of the last request.

Once the analytics object has been processed by the transaction engine 207, the analytics system 203 issues a response to the client system 201. This response is typically constructed in such a way that the transaction between the analytics and client systems is imperceptible to the end user. This scenario is desirable to Web, or resource, server operators, but not a requirement of the taxonomy driven analytics system.

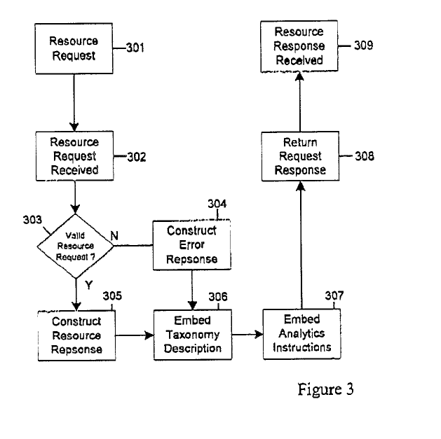

FIG. 3 is a flow diagram that details the interaction between the client and resource servers according to an embodiment of the invention. Referring to FIG. 3, the end user of the client system 201 may request a resource in an operation 301 on the client system 201 by entering a URL into the web browser 205. This request is sent to the resource server 202, as discussed above. This resource request is sent to the resource server 202, via a communications network. In an operation 302, the resource server 202 preferably receives the request from the client system 201. Upon receipt of the resource request, in an operation 303, a determination of whether the resource request is valid is preferably made by examining the request to ensure that the requested resource is available and that the client has the proper rights to access that resource. If the request is determined to be invalid in operation 303, an error response is constructed in an operation 304. However, if the request is determined to be valid, a resource response is constructed in an operation 305. Either the error response or the resource response, as appropriate, may be embedded with a taxonomy description in an operation 306. An analytics instruction may be embedded therein in an operation 307. The combined error response/resource response, taxonomy description and analytics instructions may be returned as a request response to the client system 201 in an operation 308. In an operation 309, the client system 201 preferably receives the resource response from the resource server 202. It should be understood that the taxonomy can be used to track both valid, and failed requests. This is of interest to Web server operators who desire to ensure the operational integrity of the servers that they operate.

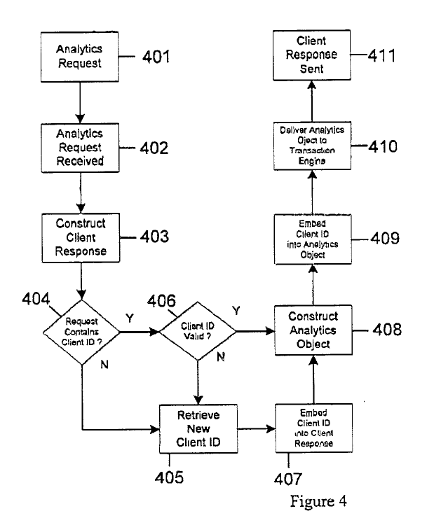

FIG. 4 is a flow diagram that details the interaction between the client system and the request normalizer according to an embodiment of the invention. After the client system 201 receives the response, which includes the embedded analytics data, from the resource server 202, the client system 201 preferably sends an analytics request, containing the taxonomy description, to the analytics system 401 in an operation 401. Managing the client interaction is the primary role of the request normalizer 206 of the analytics system 203.

After receiving the analytics request in an operation 402, the request normalizer 206 constructs a client response in an operation 403. The delivery is this response to the client is delayed pending the determination of the presence, or the validity, of the client identifier. If it is determined in operation 404 that the analytics request does not contain a client identifier, a client identifier may be retrieved from the client identifier server 211 in an operation 405. If it is determined that the analytics request contains a client identifier, it is preferably determined whether the client identifier is a valid client identifier in an operation 406. If in operation 406 the client identifier is deemed to be invalid, a new client identifier is preferably assigned in the operation 405. The newly assigned client identifier may then be embedded into the client response 403 in an operation 407. Having determined the existence of a valid client identifier, the request normalizer 206 preferably parses the additional data contained the analytics request and reformats the data to construct a message to be sent to the transaction engine in an operation 408. The message is referred to as the analytics object. The request normalizer may embed the client identifier in the information contained in the analytics object in an operation 409. The analytics object is then preferably sent to the transaction engine 207 in an operation 410. At a minimum, the data contained in the analytics object includes the client identifier, the taxonomy description sent in the analytics request, and the time at which the analytics request was received by the analytics system. The data in the analytics object is preferably formatted in a way to minimize and simplify the parsing required by the transaction engine 207.

Once the analytics object has been delivered to the transaction engine 207, the request normalizer 206 issues its response to the client system in an operation 411. If the analytics request sent by the client system 201 did not contain a valid client identifier, the response sent to the client system 201 will preferably contain the new identifier issued by the request normalizer 206. Typically, the response sent to the client is designed in such a way that the interaction between the client and analytics systems in imperceptible to the end user. While this may be the more desirable solution for Web server operators, it is not a requirement of the taxonomy based analytics system of this embodiment.

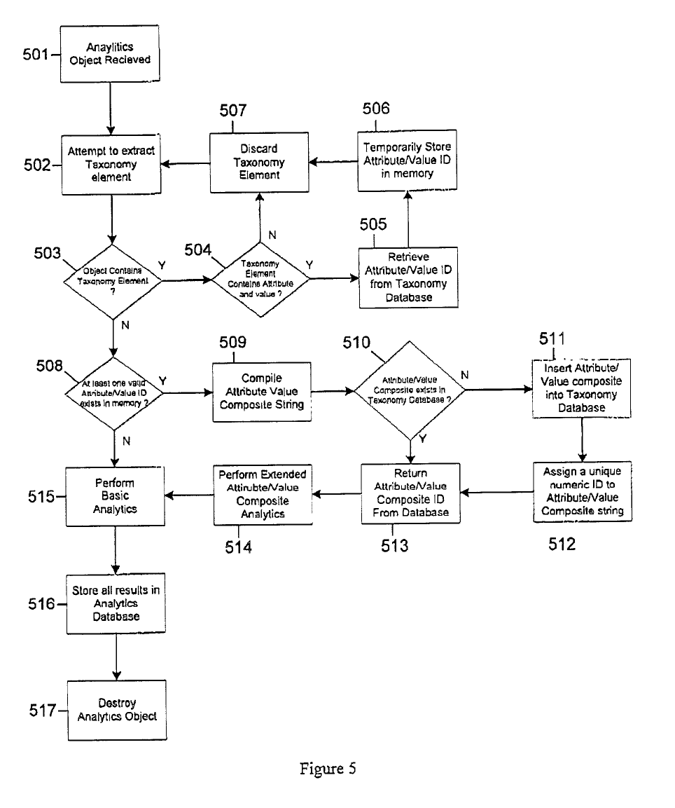

FIG. 5 is a flow diagram of an example of an algorithm for using taxonomy elements according to an embodiment of the invention. In an operation 501, the transaction engine 207 preferably receives the analytics object from the request normalizer 206. In an operation 502, the transaction engine 207 preferably attempts to extract the attribute-value pairs which comprise the taxonomy. In an operation 503, it is determined whether the analytics object contains a taxonomy element. Using the example illustrate in FIG. 1(B), the taxonomy string of “category=patent&page=figures&instance=1” would yield the three taxonomy elements of: “category=patent”, “page=figures”, and “instance=1”. Each of these attribute-value pairs are considered taxonomy elements, as described above. If the analytics object contains a taxonomy element, it is preferably determined whether the taxonomy element contains an attribute-value pair in an operation 504. If the taxonomy element does not contain an attribute-value pair, the taxonomy element is preferably discarded in an operation 507 and another attempt is preferably made to extract a taxonomy element in operation 502.

If the taxonomy element contains an attribute-value pair, a corresponding attribute-value identifier may preferably be retrieved from the taxonomy database 208 in an operation 505. The attribute-value identifier may then be temporarily stored in an operation 506. As each element is extracted, it is validated to ensure that it contains both an attribute and a value. In operation 507, the element is discarded and the analytics object is searched for the next taxonomy element in operation 502. This process continues until there are no longer any attribute-value pairs to be processed.

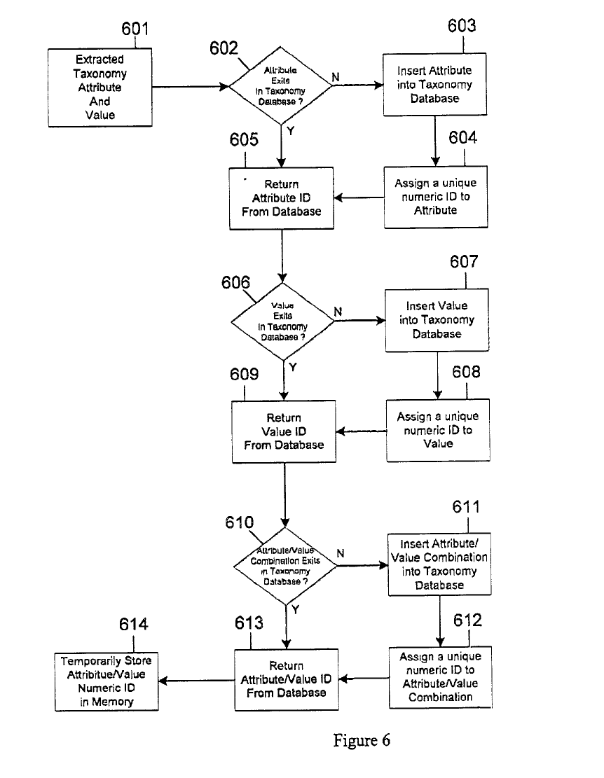

FIG. 6 is a flow diagram outlining an example of an algorithm for storing taxonomy elements in the taxonomy database according to an embodiment of the invention. The taxonomy database 208 contains an authoritative record of the attributes, values, and attribute-value pairs that the transaction engine 207 has received via client analytics requests. For each taxonomy element (i.e., “category=patent”), the transaction engine 207 preferably separates the attribute (i.e., “category”) and value (i.e., “patent”) in an operation 601. The transaction engine then searches the taxonomy database for that particular attribute in an operation 602. If that attribute does not exist, it may be inserted into the taxonomy database 208 in an operation 603 and assigned a numeric identifier in an operation 604. In the scenario in which the attribute already exists in the taxonomy database, a pre-assigned numeric attribute identifier may be returned in an operation 605. This procedure may be repeated for the corresponding values, and attribute-value combinations in operations 606-609 and 610-613, respectively. If the unique identifier is assigned in operation 604, the attribute identifier may be returned from the taxonomy database 208 in operation 605. The end result is that each attribute, value, and attribute value combination possess a unique record and corresponding identifier in the taxonomy database 208. Each of the numeric attribute-value identifiers may be temporarily stored in memory by the transaction engine for future use in operation 614.

Returning to FIG. 5, having processed all the taxonomy elements, it is determined in operation 508 whether at least one valid attribute-value identifier was obtained from the taxonomy database 208. If at least one valid attribute-value identifier was retrieved, an attribute-value composite string may be compiled in an operation 509. This string may be defined as a concatenation of all the unique numeric attribute-value identifiers extracted from a given taxonomy description, separated by a delimiter. For example, given a taxonomy description of “category=patent&page=background”, there are two attribute-value pairs: “category=patent” and “page=background”. The numeric identifiers associate with these attribute-values pairs in the taxonomy database may be 101 and 102, respectively. Therefore, the attribute-value composite string for that taxonomy description could be “.101.102.”. Where 101 is the numeric attribute-value identifier for “category-patent”, 102 is the numeric attribute-value identifier for “page=background”, and the “.” character serves as the delimiter.

Then, in an operation 510, it is preferably determined whether the attribute-value composite string exists in the taxonomy database 208. If the attribute-value composite string does not exist in the taxonomy database 208, an attribute-value composite string may be constructed by the transaction engine 207 and stored in the taxonomy database 208 in an operation 511. Thereafter, in an operation 512, a unique numeric identifier may be assigned to the attribute-value composite string. In an operation 513, the attribute-value composite identifier is preferably returned from the taxonomy database 208. In an operation 514, an extended attribute-value composite analytics may be performed. Following operation 514, basic analytics is performed in an operation 515.

Those familiar with the art understand that the types of analysis which can be performed upon the data contained in the client analytics requests may vary One typical example of such an analysis is tracking the number of requests received during a specified time period, an hour for example. In the event that the client analytics requests, and their resulting analytics objects, do not include a valid taxonomy description, the total number of requests received during a given time period may be determined (i.e. requests per hour). While this information is relevant, it is limited in its utility. If client analytics requests do contain valid taxonomy descriptions, analytics may be performed not only based upon the total number of analytics objects received, but also the taxonomy composite and attribute-value identifiers. The taxonomy based analytics provides not only the number of requests received in a given time period (hour), but analytics data based upon the contextual information contained in the requests.

For example, assuming an analytics system receives 100 requests in a given hour. 50 of which contain the taxonomy description “category=patent&page=background”, 25 of which are labeled as “category=patent&page=figures&instance=1”, and 25 or which are labeled “category=patent&page=figures&instance=2”. In the absence of the taxonomy information, it may be reported that 100 requests were received in the given hour, without any insight as to the nature of those requests. However, with the taxonomy descriptions, not only the number, but the context of the requests is determined. In this example, it can be seen that of the 100 total requests, 50 were for background pages, and 50 were for figures. Of the 50 requests for figures, 25 were for FIG. 1, and 25 were for FIG. 2.

The results of both the attribute-value composite and basic analytics may be stored in the analytics database in an operation 516. Thereafter, the analytics object is destroyed in an operation 517. If in operation 508, it is determined that there are no attribute-value identifiers stored in the taxonomy database, the procedure of this embodiment proceeds directly to operation 515, where basic analytics are performed and the procedure continues on to operations 516 and 517.

The information in the taxonomy and analytics databases may then be leveraged by other computing applications either for informational purposes or as input to other business logic based applications.

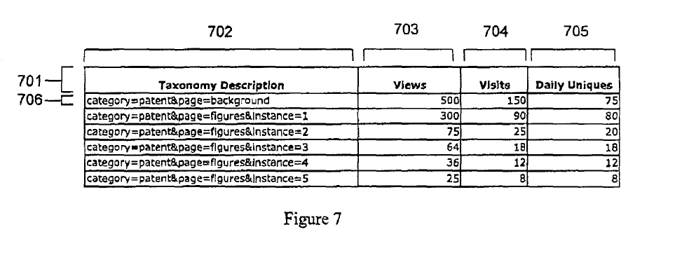

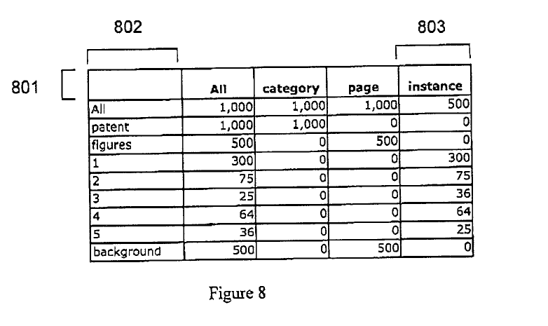

Those familiar with the art understand that various computer programs may access information stored in databases. These programs are typically written for reporting purposes or to perform further analytics. FIGS. 7-8 are sample outputs generated by one manifestation of a reporting application that utilizes the data stored in the analytics and taxonomy databases 209, 208. These sample outputs are intended merely to illustrate the added utility of taxonomy driven analytics used in conjunction with client identifiers and visitor profiles according to an embodiment of the invention.

FIG. 7 is an example of a utilization report which details resource utilization based upon the taxonomy description. The leftmost column of the report 702, lists all the taxonomy description strings received by the analytics system during the time period specified. In addition to the “Taxonomy Description” label, the topmost row in the report describes the values presented. The numerical values in the “Views” column 703, represent the number of times that a particular resource was requested from the Web site. The “Visits” 704 and “Daily Uniques” 705 values are representative of the resource usage patterns by individual end users, or client systems. The analytics system makes use of the Client Identifier contained in the analytics request in order to calculate the values in the “Visits” and “Daily Unique” columns.

Visits, and in turn visitors, are tracked by the analytics system using the client identifiers contained in the analytics request. A visit begins when the analytics system receives its first request from a particular client system. As more requests arrive in the analytics system with same client identifier, they are attributed to the same visit. If the time between requests from a single client identifier is greater than some threshold, the analytics system terminates the visit. Those familiar with the art typically define this threshold to be thirty minutes, but this is not a requirement of the analytics system.

The term unique is used to distinguish the number of individual visitors (client systems) from the number of total visits. It is a count of the unique client identifiers seen by a given analytics system over a given time period. For “Daily Uniques”, this is the number of unique client identifiers seen in a given day.

The numbers in the “Visits” column 704 of FIG. 8 are representative of the number of visits a resource received. If a Visitor were to access the same resource twice within a single visit. This resource will be attributed a single visit count. If the end user's first visit were to be terminated, and they returned for a second visit in which they accessed the same resource, the visit count for that resource would be incremented.

Analogously, the values in the “Daily Uniques” column 804 of FIG. 8 are representative of the number of unique client systems that accessed a given resource. Assuming that in a given day, a single client system was to access the same resource over the course of three visits. Given that the same client system accessed that resource, the daily unique count for that resource would have a value of 1. If another client system were to access that resource, this would be considered another “Daily Unique” and the subsequent count would be incremented.

Referring to FIG. 7, the sample data for the taxonomy description “category=patent&page=background” 706 reveals that that resource was accessed, or viewed, 500 times, over the course of 150 visits, by 75 unique client systems. From the “Views” component of this data, a resource server operator may understand how frequently the resource is being accessed. Using the “Visits” and “Daily Uniques” data in conjunction with that of the “Views”, they can infer the usage patterns for individual users.

More specifically, by dividing the number of Views by the number of Visits, a site operator can understand the likelihood that a user will return to a given resource during the course of a single visit. In this particular case, end users tended to view this resource between three and four times per visit (i.e. 500 divided by 150). Additionally, by comparing the number of “Visits” with the number of “Daily Uniques”, an operator can understand how likely the same end user is to return to the same resource in a given day. Again, for this particular taxonomy description, 75 unique visitors visited the same resource an average of twice in one day.

FIG. 8 is a resource utilization report that displays the taxonomy information in a matrix format. The first row of the report lists all the taxonomy attributes received by the analytics system, in addition to the keyword “All” 801. The leftmost column in the report lists all the taxonomy values received by the analytics system, in addition to the keyword “All” 802. In both cases, the keyword “All” represents an aggregate of the total requests for all attributes, or all values. The numeric values displayed at the intersection of a given row (attribute) and column (value) are equal to the number of times that the analytics system received a taxonomy string which contained that particular attribute-value combination. The report displays values for data collected over the period of a single day.

The utility of this report is best understood by closely examining the data. The value at the intersection of the first attribute “All”, and the first value “All”, represents the total number of resource accesses received during the specified day. For this particular report, this value is equal to 1,000. Therefore, the resource server which has integrated this analytics system has received 1,000 resource requests during the specified time period.

Closer examination of the data yields more granular insight into the nature of the requests. The value at the intersection of the attribute “page” with the value “figures” is 500. While the value at the intersection of the attribute “page” with the value “background” is 500 as well. Given that there are 1,000 total resource requests, it is evident that half of the requests, i.e., 500, were for pages containing figures and the remaining half, i.e., 500, were for the background page. By viewing this data, a Web site operator may then conclude that there is equal interest in the “background” and “figures” pages of their Web site.

In this taxonomy example, the attribute “instance” is used to identify the resource requests which were for figures one through five. By examining the number of requests in the “instance” column 803 from top to bottom, it is evident that they are 500, 300, 75, 64, 36 and 25 for the values “All”, “1”, “2”, “3”, “4”, and “5”, respectively. The Web site operator could conclude from this data the there is less interest in FIG. 5 (25 requests) than in FIG. 1 (300 requests). Additionally, given that the number of requests diminish as the figures are traversed from figure one to figure five, it may be concluded that end users lose interest in the content of the figures as they are traversed.

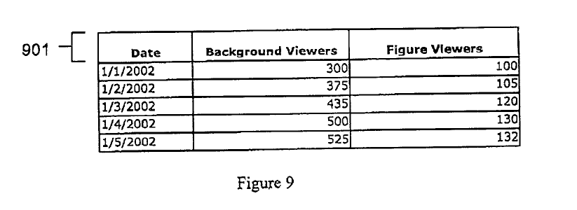

FIG. 9 is another sample report that leverages the combination of the visitor profile and taxonomy utilization data. It is often useful for a resource server operator to classify end users, or client systems, based upon the nature of the requests that they issue. This embodiment of the taxonomy based analytics system terms these classifications “segments”.

Segments are arbitrary visitor categorizations created by Web site operators. A visitor is considered to be a member of a particular segment provided that they match the criterion specified by the Web site operator when the segment was defined. The segment criterion are comprised of the data elements from the taxonomy and analytics databases.

The report in FIG. 9 illustrates, for example, the changes in segment membership over five days. The topmost row in the report 901 lists the type of values displayed: “Date”, “Figure Viewers”, and “Background Viewers”. The values in the “Date” column tell the Web site operator on which day the segment data was collected The “Figure Viewers” and “Background Viewers” represent example segment definitions that could be defined by a resource server operator.

In this example, visitors belong to a particular segment based upon the number of times they view a particular resource within the timeframe of a single visit. A visitor is considered a “Background Viewer” if the analytics system receives the taxonomy element “page=background” two times from the same client identifier during the same visit. The segment name, taxonomy element, and number of views required are specified by the web site operator during the definition of the segment. A visitor is considered a “Figure Viewer” if the analytics system receives the taxonomy element “page=figure” once from the same client identifier during the same visit. While these segment definitions are focused upon single taxonomy elements and their counts within a visit, those familiar with the art can understand how other data in the taxonomy and analytics databases can be leveraged to create meaningful segments.

By examining the data in the report, it can be seen that while membership the “Background Viewers” segment has been growing over time, that of the “Figure Viewers” segment has not. Meaning that as new visitors arrive at the site, they tend to access resources whose descriptions contain “page-background”. A Web site operator could interpret this data to mean that the “page=figure” sections are not appealing to new visitors. Using this and other information contained in the taxonomy and analytics databases, the Web site operator can make modifications to the Web site offerings to produce more desirable usage patterns.

What is claimed is:

1. A system monitoring computer resource utilization, comprising:
a client system in which a user requests access to a computing resource;
a resource server to receive the resource request from the client system and to transmit a response to the client system, the response including a natural language taxonomy description corresponding to the requested computer resource; and
an analytics system to receive an analytics request from the client system, the analytics request including the natural language taxonomy description corresponding to the requested computer resource and client information, wherein the analytics system stores the natural language taxonomy description and the client information and determines resource utilization patterns from the stored natural language taxonomy description and client information.

2. The system of claim 1, wherein the computer resource is accessed over the Internet.

3. The system of claim 1, wherein the response from the resource server to the client system includes at least data requested by the client system, additional instructions for the client system to perform and the natural language taxonomy description corresponding to the requested computing resource.

4. The system of claim 1, wherein the client information includes a unique client identifier.

5. The system of claim 1, wherein the analytics system creates a unique client identifier if the client information does not include a client identifier and transmits the client identifier to the client system.

6. The system of claim 1, wherein the natural language taxonomy description is created by the computing resource.

7. The system of claim 1, wherein the analytics system extracts the natural language taxonomy description contained in the analytics request from the client system.

8. The system of claim 7, wherein the analytics system assigns a numeric taxonomy identifier to the natural language taxonomy description.

9. The system of claim 8, wherein the numeric taxonomy identifier is used in concert with the client identifier to calculate data relating to the resources which were accessed by the client system.

10. The system of claim 9, wherein calculations are stored in an analytics database in the analytics system.

11. The system of claim 10, wherein the calculations are output in a utilization report.

12. The system of claim 1, wherein the analytics system comprises a request normalizer, a transaction engine, a taxonomy database, an analytics database, a client identifier database a client identifier server and a reporting engine.

13. The system of claim 12, wherein the request normalizer determines whether the analytics request contains a valid client identifier and retrieves a client identifier stored in the client identifier database from the client identifier server if the analytics request does not contain a valid client identifier.

14. The system of claim 13, wherein the request normalizer constructs an analytics object from the client identifier and the natural language taxonomy description and sends the analytics object to the transaction engine.

15. The system of claim 14, wherein the transaction engine:
disassembles the natural language taxonomy description into attribute-value pairs, wherein each attribute and value has a corresponding entry in the taxonomy database in addition to a numeric identifier,
creates an attribute-value composite string which is stored in the taxonomy database and assigned a unique identifier, and
generates a visitor profile from the data stored in the taxonomy database and the client identifier, wherein the visitor profile is a historic record of the activity of the client system and may include at least a number of computing resources requested, a first resource requested, a last resource requested, a date and time of the first request and a date and time of the last request.

16. A method for profiling a computer resource visit by processing a natural language taxonomy description transmitted by a computer resource accessed by a visitor together with a respective unique visitor identifier.

17. A method comprising:
requesting access to a computer resource;
transmitting a response to the request, the response including a natural language taxonomy description corresponding to the requested computer resource; and
transmitting an analytics request, the analytics request including the natural language taxonomy description and client information corresponding to a user requesting access to the computer resource;
processing the natural language taxonomy description and the client information to determine resource utilization patterns of the user.

18. The method of claim 17, further comprising:
determining whether the client information includes a client identifier;
retrieving a client identifier from a database if the client information does not include a client identifier;
determining whether the client identifier is valid;
retrieving a new client identifier if the client identifier is invalid;
constructing an analytics object, the analytics object including at least the client identifier, the natural language taxonomy description, and a time at which the analytics request was received; and
transmitting a response to the analytics request.

19. The method of claim 18, further comprising:
extracting attribute-value pairs which comprise the analytics object;
retrieving a corresponding attribute-value identifier for each attribute-value pair from a database;
compiling an attribute-value composite string from each of the attribute-value pairs and the corresponding attribute-value identifier; and
performing analytics on each attribute-value composite string.

20. A computer readable medium storing a program for executing a process comprising:
requesting access to a computer resource;
transmitting a response to the request, the response including a natural language taxonomy description corresponding to the requested computer resource; and
transmitting an analytics request, the analytics request including the natural language taxonomy description and client information corresponding to a user requesting access to the computer resource;
processing the natural language taxonomy description and the client information to determine resource utilization patterns of the user.

21. The method of claim 17, further comprising preparing a utilization report including the resource utilization patterns of the user.
